(19) United States
(12) Patent Application Publication
(10) Pub. No.: US 2025/0292928 A1
(43) Pub. Date: Sep. 18, 2025

(54) CONDUCTIVE NANOSTRUCTURE

(71) Applicant: KOREA INSTITUTE OF SCIENCE AND TECHNOLOGY, Seoul (KR)

(72) Inventors: Myoung-Woon MOON, Seoul (KR); Young A LEE, Seoul (KR); Min-Seok KIM, Seoul (KR); Sang Jin PARK, Seoul (KR); You Jun LEE, Seoul (KR); Chang Soo KIM, Seoul (KR)

(21) Appl. No.: 18/978,751

(22) Filed: Dec. 12, 2024

(30) Foreign Application Priority Data
Mar. 18, 2024 (KR) 10-2024-0037013

(51) Int. Cl. H01B 1/00

(52) U.S. Cl. CPC H01B 1/00

(57) ABSTRACT

Provided is a conductive nanostructure comprising a core region made of cellulose nanocrystals and a first shell region that alternately includes a metal pattern and a carbon structure. The conductive nanostructure may take forms such as a nanowire, nanotube, nanocolumn, pillar, or cone, and exhibits dimensions ranging from 50 nm to 50 μm in height and 10 nm to 1000 nm in diameter.

### CROSS-REFERENCE TO RELATED APPLICATION

This U.S. non-provisional patent application claims priority under 35 U.S.C. § 119 of Korean Patent Application No. 10-2024-0037013, filed on Mar. 18, 2024, the entire contents of which are hereby incorporated by reference.

### BACKGROUND

The present disclosure herein relates to a conductive nanostructure, and more particularly, to a conductive nanostructure including cellulose nanocrystals.

Cellulose nanocrystals are nanoscale crystals extracted from cellulose. The cellulose nanocrystals are primarily produced through acid hydrolysis of cellulose, and in this process, amorphous regions may be removed, resulting in nanoscale crystalline cellulose. The cellulose nanocrystals may typically exhibit high strength. The cellulose nanocrystals, given their high strength and eco-friendly nature, are being explored for applications that impart conductivity.

### SUMMARY

The present disclosure provides forming a conductive nanostructure.

An embodiment of the inventive concept provides a conductive nanostructure including a core region and a first shell region covering the core region, wherein the core region includes cellulose nanocrystals, and the first shell region includes a metal pattern and a carbon structure that are alternately repeated.

In some embodiments, the conductive nanostructure may take the form of a nanowire, a nanotube, a nanocolumn, a pillar, or a cone.

In some embodiments, the conductive nanostructure may have a height of about 50 nm to about 50 μm.

In some embodiments, the metal may include at least one of iron, aluminum, silicon, gold, silver, platinum, or copper.

In some embodiments, the core region may extend along a first direction, and the metal pattern and the carbon structure may be stacked along the first direction.

In some embodiments, the conductive nanostructure may further include a substrate connected to one end of the core region, wherein the substrate may be an insulating material substrate or a metal substrate.

In some embodiments, the insulating material substrate may include stacked cellulose nanocrystals.

In some embodiments, the metal substrate may include at least any one of aluminum, copper, nickel, stainless steel, or titanium.

In some embodiments, the conductive nanostructure may further include a second shell region covering the first shell region, wherein the second shell region may be spaced apart from the core region with the first shell region therebetween.

In some embodiments, the second shell region may be connected to a metal pattern and a carbon structure that are adjacent in the first shell region.

In some embodiments, the second shell region may include a carbon liner.

In some embodiments, the second shell region may have a smaller thickness than the first shell region.

In some embodiments, the carbon structure may have a thickness of about 1 nm to about 50 nm, and the metal pattern may have a thickness of about 1 nm to about 20 nm.

In some embodiments, the conductive nanostructure may have a diameter of about 10 nm to about 1000 nm.

In some embodiments, the conductive nanostructure may have an aspect ratio of about 1 to about 500.

In an embodiment of the inventive concept, a conductive nanostructure includes a substrate, a plurality of core regions disposed on the substrate and taking the form of a nanowire, a nanotube, a nanocolumn, a pillar, or a cone, and shell regions covering each of the core regions, wherein each of the core regions includes a matrix including cellulose nanocrystals, and carbon particles disposed within the matrix, and each of the shell regions includes a metal pattern and a carbon structure that are alternately repeated along a height direction of the core regions.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a schematic view showing a conductive nanostructure according to some embodiments of the inventive concept;

FIG. 2A is an enlarged view showing aa of FIG. 1;

FIG. 2B is an enlarged view corresponding to aa of FIG. 1;

FIG. 3 is a view showing a shell region observed through atom probe tomography;

FIG. 4 is a schematic view showing a conductive nanostructure according to some embodiments of the inventive concept;

FIG. 5A shows an image of a conductive nanostructure (nanowire) according to some embodiments of the inventive concept, observed through a scanning electron microscope (SEM);

FIG. 5B shows an image of a conductive nanostructure (nanotube) according to some embodiments of the inventive concept, observed through a scanning electron microscope (SEM);

FIG. 6A is a schematic view showing a substrate processing device using an ion beam for manufacturing a conductive nanostructure;

FIG. 6B is a view showing a process for manufacturing a conductive nanostructure;

FIG. 7 is a graph showing a height of a conductive nanostructure vs. ion beam exposure duration;

FIG. 8 is a graph showing resistivity of a conductive nanostructure vs. voltage; and

FIG. 9 is a graph showing current vs. voltage of a conductive nanostructure group.

### DETAILED DESCRIPTION

Hereinafter, a conductive nanostructure according to an embodiment of the inventive concept will be described with reference to the accompanying views.

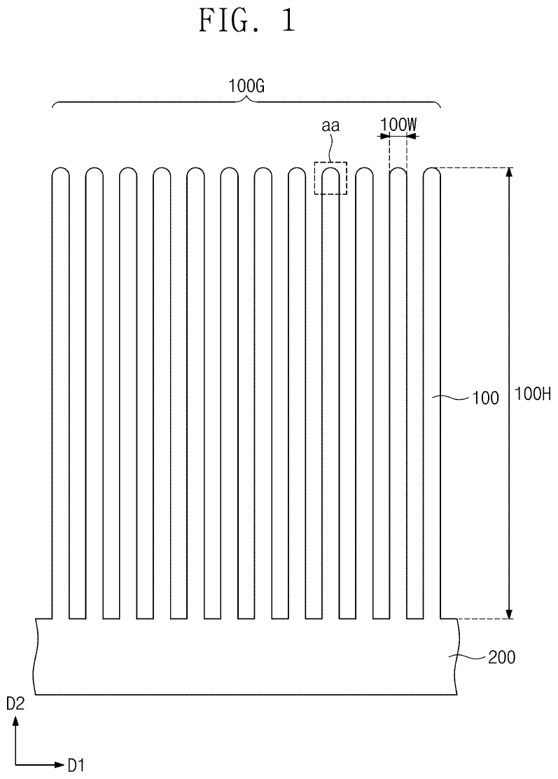

FIG. 1 is a schematic view showing a conductive nanostructure according to some embodiments of the inventive concept.

Referring to FIG. 1, a conductive nanostructure group 100G may be provided. The conductive nanostructure group 100G may include a plurality of conductive nanostructures 100. The conductive nanostructures 100 may be disposed along a first direction D1. The conductive nanostructures 100 may take the form extending in a second direction D2 perpendicular to the first direction D1. The conductive nanostructures 100 may take the form of nanowires, nanotubes, nanocolumns, pillars, or cones. The conductive nanostructures 100 may include one edge and the other edge. One edge of each of the conductive nanostructures 100 may be independently separated. The other edge of each of the conductive nanostructures 100 may be connected to an insulating material substrate 200. The conductive nanostructures 100 may protrude from the insulating material substrate 200 in a second direction D2. The insulating material substrate 200 may include an insulating material. The insulating material may include stacked cellulose nanocrystals.

The conductive nanostructures 100 may have a first diameter 100W of about 10 nm to about 1000 nm. The first diameter 100W may be a width along the first direction D1 parallel to an upper surface of the insulating material substrate 200 of the conductive nanostructures 100. The conductive nanostructures 100 may have a first height 100H of about 50 nm to about 50 μm. The first height 100H may be a width along the second direction D2 perpendicular to an upper surface of the insulating material substrate 200 of the conductive nanostructures 100. An aspect ratio of the first height 100H of the conductive nanostructures 100 divided by the first diameter 100W may be about 1 to about 500. For example, the conductive nanostructures 100, when taking the form of a conductive nanotube, may have a first height 100H of about 500 nm or less, and a wall forming the nanotube may have a thickness of about 10 nm to about 15 nm.

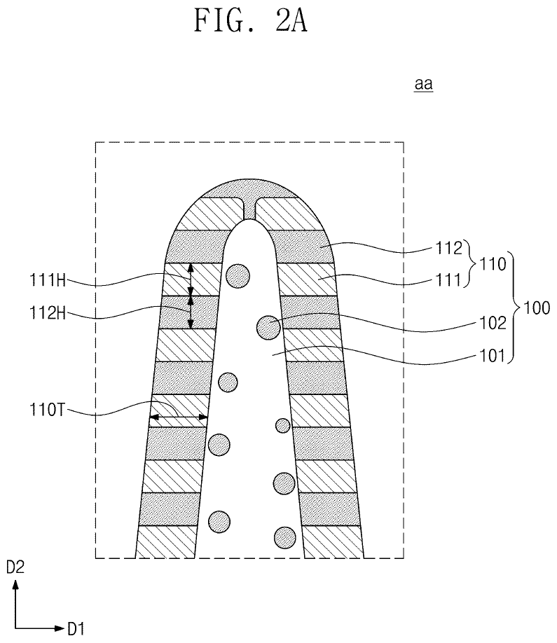

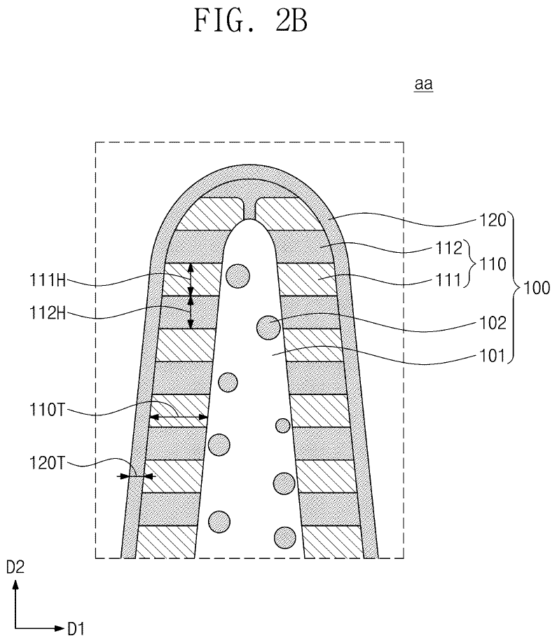

FIG. 2A is an enlarged view showing aa of FIG. 1.

Referring to FIGS. 1 and 2A, the conductive nanostructures 100 may include a core region 101 and a shell region 110.

The core region 101 may take the form of a nanowire or a nanotube. One end of the core region 101 may be connected to the insulating material substrate 200. The core region 101 may include cellulose nanocrystals. The core region 101 may be a matrix formed of cellulose nanocrystals. The core region 101 may have carbon particles 102 dispersed therein.

The shell region 110 may cover the core region 101. The shell region 110 may include a metal pattern 111 and a carbon structure 112 that are alternately and repeatedly stacked along the second direction D2. The metal pattern 111 may have a first height 111H in the second direction D2. The carbon structure 112 may have a second height 112H in the second direction D2. The first height 111H and the second height 112H may be the same as or different from each other. For example, the first height 111H may be about 3 nm to about 5 nm, and the second height 112H may be about 2 nm to about 5 nm. As another example, the first height 111H may be about 10 nm to about 20 nm. As another example, the first height 111H may be about 3 nm to about 20 nm.

The metal pattern 111 may include, for example, iron or aluminum. The carbon structure 112 may include carbon and oxygen. The carbon structure 112 may include at least any one of graphite, amorphous carbon, or hard carbon. According to some embodiments, oxygen may be provided in a portion of the first shell region 110. The oxygen may be provided between the metal pattern 111 and the carbon structure 112.

FIG. 2B is an enlarged view corresponding to aa of FIG. 1. Except for the descriptions below, descriptions of FIG. 2B are the same as those described with reference to FIGS. 1 and 2A, so any redundant descriptions will be skipped.

The conductive nanostructures 100 may further include a second shell region 120. The shell region 110 described above in FIGS. 1 and 2A may be referred to as a first shell region 110. The second shell region 120 may cover the first shell region 110. The second shell region 120 may be spaced apart from the core region 101 with the first shell region 110 therebetween. A thickness 120T of the second shell region 120 may be smaller than a thickness 110T of the first shell region 110. The thickness 110T of the first shell region 110 indicates a distance from an upper surface to a lower surface of the first shell region 110. The thickness 120T of the second shell region 120 indicates a distance from an upper surface to a lower surface of the second shell region 120. The second shell region 120 may take the form of a line in a cross-section. The second shell region 120 may be a carbon liner formed of carbon. The second shell region 120 may electrically connect the metal pattern 111 and the carbon structure 112 that are positioned adjacent in the first shell region 110 more easily.

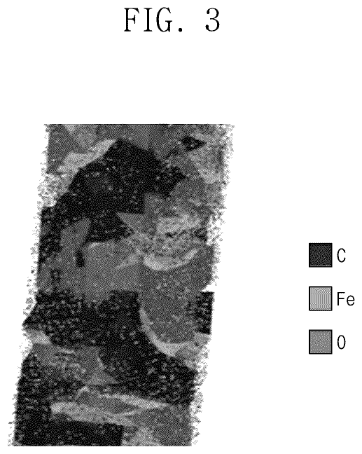

FIG. 3 is a view showing a shell region observed through atom probe tomography.

Referring to FIG. 3, it is observed that iron (Fe), representing a metal pattern, and carbon (C), representing a carbon structure, are alternately and repeatedly disposed. Oxygen (O) is also included within carbon structure.

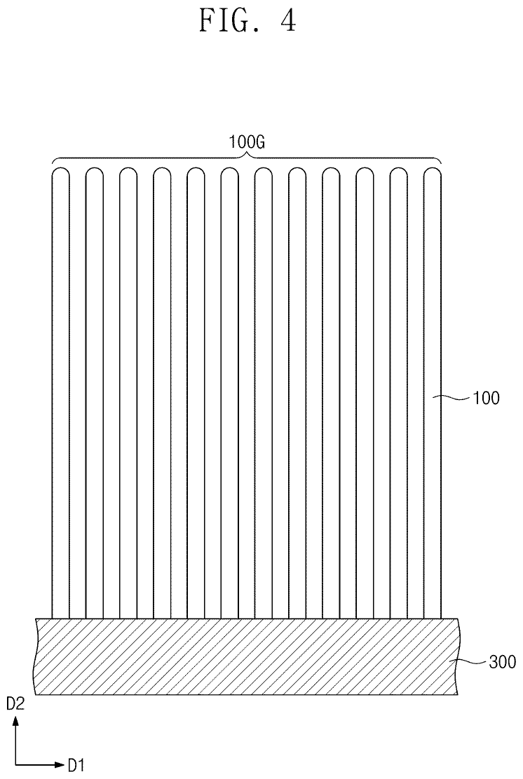

FIG. 4 is a schematic view showing a conductive nanostructure according to some embodiments of the inventive concept. Except for the descriptions below, descriptions of FIG. 4 overlap those described in FIGS. 1 and 2, so any redundant descriptions will be skipped.

Referring to FIG. 4, a metal substrate 300 connected to the conductive nanostructures 100 may be provided. The metal substrate 300 may serve as a current collector of an electrode of a sensor or an electrode of a secondary battery. The secondary battery may include any one of a lithium secondary battery including a lithium ion battery, a lithium metal battery, a lithium sulfur battery, and a lithium air battery, and a sodium ion battery. The insulating material substrate 200 may not be provided or may not be substantially present between the metal substrate 300 and the conductive nanostructures 100. The metal substrate 300 may include at least any one of aluminum, copper, nickel, stainless steel, or titanium. For example, the metal substrate 300 may serve as a current collector of an anode of a lithium secondary battery. In this case, each of the conductive nanostructures 100 may serve as an anode material. According to some embodiments, when the conductive nanostructures 100 are used as an anode material, graphite, silicon, or the like may be added to the anode material to form a composite material. According to an embodiment of the inventive concept, when the conductive nanostructures 100 are used as an anode material, dendrite formation during a charge-discharge process of a lithium secondary battery may be inhibited, leading to an increase in lifespan of the lithium secondary battery. According to some embodiments, the conductive nanostructures 100 may also be utilized as an anode material in anode-free lithium metal batteries.

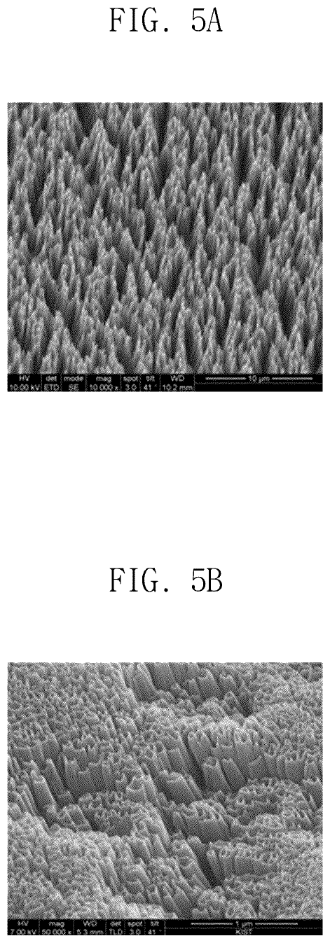

FIG. 5A shows an image of a conductive nanostructure according to some embodiments of the inventive concept, observed through a scanning electron microscope (SEM). FIG. 5B shows an image of a conductive nanostructure according to some embodiments of the inventive concept, observed through a scanning electron microscope (SEM).

Referring to FIG. 5A, a conductive nanostructure may take the form of a nanowire. Referring to FIG. 5B, a conductive nanostructure may take the form of a nanotube.

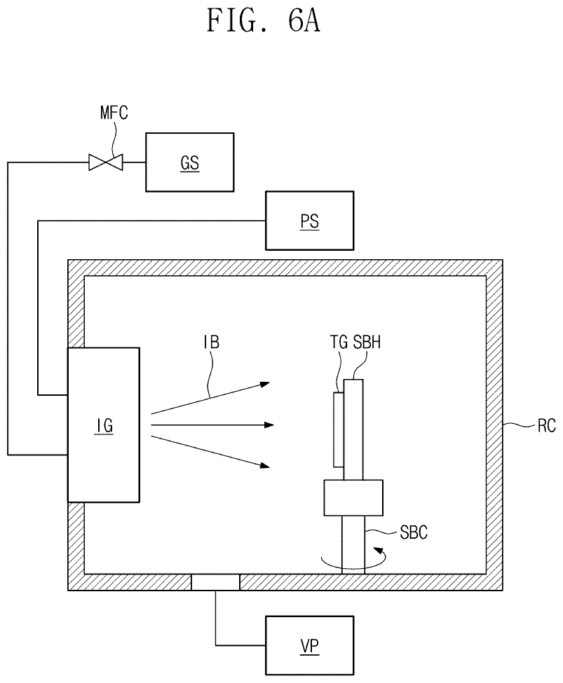

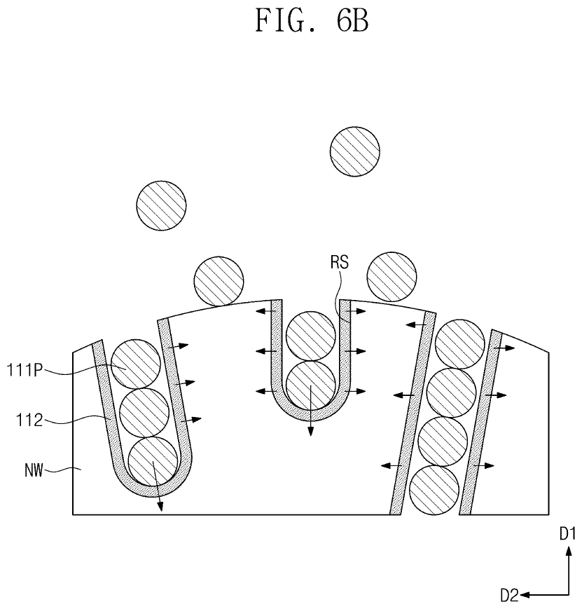

FIG. 6A is a schematic view showing a substrate processing device using an ion beam for manufacturing a conductive nanostructure. FIG. 6B is a view showing a process for manufacturing a conductive nanostructure.

Referring to FIG. 6A, a processing device may be provided. A substrate processing device may be a device that performs processing on an insulating material substrate using an ion beam. For example, the substrate processing device may be a device that performs an etching process and the like on an insulating material substrate using an ion beam. The substrate processing device may include an ion beam source IG, a process chamber RC, a substrate support SBH, a gas supply unit GS, a power supply unit PS, and a vacuum pump VP.

First, a method for manufacturing a conductive nanostructure may include preparing an insulating material substrate on which cellulose nanocrystals are stacked. For example, cellulose nanocrystal powder may be dispersed in deionized water to prepare a solution. For example, 0.2 g of cellulose nanocrystal powder may be mixed with 10 ml of deionized water to form a solution. Then, the solution may be applied onto a sheet. The solution on the sheet may be dried to form an insulating material substrate including stacked cellulose nanocrystals, and this may serve as a target TG.

The target TG may be attached to the substrate support SBH. The gas supply unit GS may supply argon gas (Ar) and oxygen gas (O₂) to the ion beam source IG. A gas control unit MFC may be placed between the ion beam source IG and the gas supply unit GS to control the amount of gas supplied to the ion beam source IG. The power supply unit PS may supply power to the ion beam source IG. The ion beam source IG may be an ion gun. The ion beam source IG may convert gas supplied from the gas supply unit GS into plasma. Argon ions and oxygen ions may be extracted from the plasma to generate an ion beam IB. The ion beam IB may be accelerated to reach the target TG. The process chamber RC may provide a process space. The target TG may be processed within the process space. The process chamber RC may be connected to the ion beam source IG. The substrate support SBH may be positioned within the process chamber RC. The substrate support SBH may be connected to a substrate control unit SBC. The substrate control unit SBC may alter an inclination angle of the substrate support SBH and/or rotate the substrate support SBH. The vacuum pump VP may be connected to the process chamber RC. Through the vacuum pump VP, the process space may be maintained in a substantial vacuum state during the process.

For example, the ion beam source IG may be operated under the condition of DC 3 kV/6 kW. The ion beam source IG may have a pressure of about 10⁻² torr or less. The process chamber RC may have a pressure of about 10⁻⁵ torr. An area of the ion beam IB may correspond to an area of the target TG. The ion beam IB may have an ion fluence of about 1×10¹⁵ to about 9.602×10¹⁸ ions/cm². The specific process conditions as above may vary depending on the experimental design.

As the target TG is irradiated with the ion beam IB, an insulating material substrate including stacked cellulose nanocrystals may be etched. Depending on the etching conditions, the insulating material substrate may be etched to form a plurality of nanowires or a plurality of nanotubes (see FIG. 1). In addition, nanowires may be controlled in size and density by regulating ion beam irradiation time and the ion beam irradiation amount.

Metal ions may be implanted onto the target TG concurrently with the irradiation of the ion beam IB. The implanting of the metal ions may include at least any one of sputtering or ion implantation. According to some embodiments, the implanting of the metal ions may be performed through metal ions generated when the process chamber RC collides with the ion beam IB during the ion beam IB irradiation process, without a separate additional process. The metal ions may include iron ions and/or aluminum ions.

Referring to FIGS. 2A and 6B, a recess RS may be formed on a side surface of a nanowire (or nanotube) NW through a side etching according to the ion beam IB. The recess RS may have a depth in the first direction D1. The depth of the recess RS may increase while the irradiation of the ion beam IB and the metal implanting are performed.

Metal ion particles 111P may be implanted into the recess RS. The metal ion particles 111P may aggregate to form the metal pattern 111 of FIG. 1. The metal ion particles 111P may carbonize adjacent cellulose nanocrystals. The cellulose nanocrystals may be carbonized to become the carbon structures 112, and the carbon structures 112 has a height increasing in the second direction D2. Through these processes, the first shell region 110 including metal the pattern 111 and the carbon structure 112 that are alternately and repeatedly disposed in FIG. 2 may be formed. A region of the nanowire NW with no penetration of the metal ion particles 111P may become the core region 101. The carbon particles 102 may also be formed within the core region 101. According to some embodiments, the second shell region 120 surrounding the first shell region 110 may be formed through the carbonization process (see FIG. 2B).

During the ion beam irradiation process, a substrate composed of stacked cellulose may partially remain (see FIG. 1) or may completely be removed substantially (see FIG. 4). When the metal substrate 300 is disposed below an insulating material substrate composed of cellulose prior to the ion beam irradiation process and the insulating material substrate placed below nanowires is substantially completely removed, a conductive nanostructure directly connected to the metal substrate 300 may be formed.

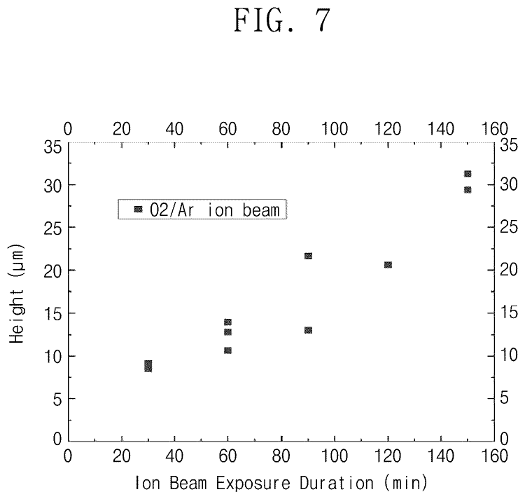

FIG. 7 is a graph showing a height of a conductive nanostructure vs. ion beam exposure duration. It was determined that the conductive nanostructure had an increase in height as the ion beam etching process increased.

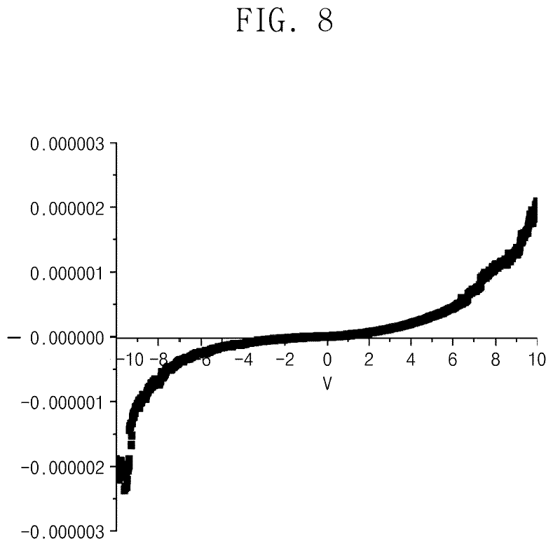

FIG. 8 is a graph showing resistivity of a conductive nanostructure vs. voltage.

Referring to FIG. 8, resistivity was measured by applying voltage to a conductive nanostructure through 4 point probe measurement. At a voltage of about 10 V or greater, the resistivity was measured to be about 3.35×10⁻³ Ωcm. When this is converted to electrical conductivity, it is seen that the conductive nanostructure has conductivity, with an electrical conductivity of 297 S/cm.

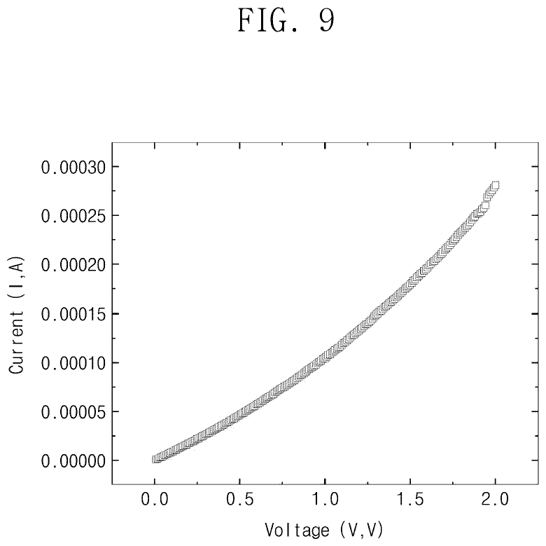

FIG. 9 is a graph showing current vs. voltage of a conductive nanostructure group.

Referring to FIG. 9, current was measured by applying voltage to a conductive nanostructure group through 4 point probe measurement. It is determined that the current tends to increase as voltage is applied. In addition, the sheet resistance (Ω/□) was measured and observed to be about 0.01 to about 3000Ω□. It is determined that this is higher than a metal (e.g., stainless steel (SUS))) having a sheet resistance of about 0.002Ω/□, but lower than a cellulose nanocrystal having a sheet resistance of about 10⁸Ω/□ or greater. It is determined that the conductive nanostructure group has a sheet resistance closer to that of a metal than an insulating material.

The conductive nanostructure according to an embodiment of the inventive concept may include a core region and a shell region covering the core region. The core region may include cellulose nanocrystals, and accordingly, the conductive nanostructure may have an elastic modulus of about 400 GPa. That is, the conductive nanostructure may have high mechanical properties. The shell region may include a metal pattern and a carbon structure that are alternately repeated.

Through to the shell region, the conductive nanostructure may have electrical conductivity close to that of a metal. Accordingly, the conductive nanostructure according to an embodiment of the inventive concept may have both mechanical properties and electrical conductivity.

The method for manufacturing a conductive nanostructure according to an embodiment of the inventive concept may involve performing processes of ion beam irradiation and metal ion implantation on a substrate composed of stacked cellulose nanocrystals concurrently to form a conductive nanostructure. That is, the process of forming a conductive nanostructure may be more efficient than other processes of imparting conductivity to cellulose nanocrystals.

A conductive nanostructure according to an embodiment of the inventive concept may include a core region including cellulose nanocrystals, and a shell region disposed on the core region. The shell region may include a metal pattern and a carbon structure that are alternately repeated, allowing the conductive nanostructure to have conductivity.

Although the embodiments of the inventive concept have been described above with reference to the accompanying drawings, those skilled in the art to which the inventive concept pertains may implement the inventive concept in other specific forms without changing the technical idea or essential features thereof. Therefore, it should be understood that the embodiments described above are exemplary in all respects and not restrictive.

What is claimed is:

1. A conductive nanostructure comprising:
a core region; and
a first shell region covering the core region,
wherein the core region includes cellulose nanocrystals, and
the first shell region includes a metal pattern and a carbon structure that are alternately repeated.

2. The conductive nanostructure of claim 1, wherein the conductive nanostructure takes the form of a nanowire, a nanotube, a nanocolumn, a pillar, or a cone.

3. The conductive nanostructure of claim 1, wherein the conductive nanostructure has a height of about 50 nm to about 50 μm.

4. The conductive nanostructure of claim 1, wherein the metal comprises at least one of iron, aluminum, silicon, gold, silver, platinum, or copper.

5. The conductive nanostructure of claim 1, wherein the core region extends along a first direction, and
the metal pattern and the carbon structure are stacked along the first direction.

6. The conductive nanostructure of claim 1, further comprising a substrate connected to one end of the core region,
wherein the substrate is an insulating material substrate or a metal substrate.

7. The conductive nanostructure of claim 6, wherein the insulating material substrate comprises stacked cellulose nanocrystals.

8. The conductive nanostructure of claim 6, wherein the metal substrate comprises at least any one of aluminum, copper, nickel, stainless steel, or titanium.

9. The conductive nanostructure of claim 1, further comprising a second shell region covering the first shell region,
wherein the second shell region is spaced apart from the core region with the first shell region therebetween.

10. The conductive nanostructure of claim 9, wherein the second shell region is connected to a metal pattern and a carbon structure that are adjacent in the first shell region.

11. The conductive nanostructure of claim 9, wherein the second shell region comprises a carbon liner.

12. The conductive nanostructure of claim 9, wherein the second shell region has a smaller thickness than the first shell region.

13. The conductive nanostructure of claim 1, wherein the carbon structure has a thickness of about 1 nm to about 50 nm, and
the metal pattern has a thickness of about 1 nm to about 20 nm.

14. The conductive nanostructure of claim 1, wherein the conductive nanostructure has a diameter of about 10 nm to about 1000 nm.

15. The conductive nanostructure of claim 1, wherein the conductive nanostructure has an aspect ratio of about 1 to about 500.

16. A conductive nanostructure comprising:
a substrate;
a plurality of core regions disposed on the substrate and taking the form of a nanowire, a nanotube, a nanocolumn, a pillar, or a cone; and
shell regions covering each of the core regions,
wherein each of the core regions includes a matrix including cellulose nanocrystals, and carbon particles disposed within the matrix, and
each of the shell regions includes a metal pattern and a carbon structure that are alternately repeated along a height direction of the core regions.
